(19) United States
(12) Patent Application Publication
(10) Pub. No.: US 2014/0074727 A1
(43) Pub. Date: Mar. 13, 2014

(54) Platform for Resolving Complaints with Customers

(71) Applicant: Lin Miao, Los Angeles, CA (US)

(72) Inventor: Lin Miao, Los Angeles, CA (US)

(21) Appl. No.: 13/609,011

(22) Filed: Sep. 10, 2012

(51) Int. Cl. G06Q 30/00

(52) U.S. Cl. CPC G06Q 30/016
USPC 705/304

(57) ABSTRACT

The present invention extends to methods, systems, and computer program products for providing a platform that enables a business to quickly and easily resolve complaints with its customers. The platform of the present invention provides a central location for accumulating complaints from customers of a business and presenting the complaints to the business for resolution. The platform also facilitates communication between the business and its customers to expedite the resolution of the complaints. In essence, the platform acts as a centralized intermediary between the customers and the businesses to promote the resolution of complaints in a fair and efficient manner.

### CROSS-REFERENCE TO RELATED APPLICATIONS

Not Applicable.

### BACKGROUND

For many businesses, especially smaller businesses, negative reviews, comments, or complaints from customers can have a significant impact on the reputation of the business. With the wide use of the internet and social media, such reviews, comments, and complaints are readily accessible to many potential customers, and can greatly influence whether a potential customer decides to do business with a particular entity. Even with large, well-known companies, negative commentary can substantially harm a company's reputation.

Oftentimes, the negative reviews, comments, or complaints can be based on a misunderstanding or mistake that a business is willing and desirous to address. For example, many customer complaints are based on the error of an employee that the business would quickly address if the business were to become aware of the error. Such errors, and other sources of negative commentary about a business, however, are often left unresolved either because the customer is unwilling or unable to contact the appropriate people within the business. In such cases, the customer often resorts to posting negative commentary online such as in social media or company reviews.

In other cases, a business is intentionally engaging in unfair or dishonest business practices. When this occurs, it may be desirable that mistreated customers provide negative commentary to warn others about the risks of transacting with the business, and to persuade the business to address its practices. If sufficient negative commentary is publicly made, the business may be forced to change its unfair or dishonest practices. Unfortunately, because the negative commentary is often provided across a large and varied number of online media, the amount of negative commentary required to have a positive influence on a misbehaving business can be excessive.

### BRIEF SUMMARY

The present invention extends to methods, systems, and computer program products for providing a platform that enables a business to quickly and easily resolve complaints with its customers. The platform of the present invention provides a central location for accumulating complaints from customers of a business and presenting the complaints to the business for resolution. The platform also facilitates communication between the business and its customers to expedite the resolution of the complaints. In essence, the platform acts as a centralized intermediary between the customers and the businesses to promote the resolution of complaints in a fair and efficient manner.

In one embodiment, a method is implemented for providing a platform through which a business can resolve complaints with its customers. A platform hosted by a server system receives complaints from a plurality of customers. Each complaint specifies a business. The platform identifies each of the received complaints that specifies a first business. The platform provides a display of the received complaints that specify the first business to a computer system of the first business. The platform receives a selection of a first complaint from the computer system of the first business. In response to the selection of the first complaint, the platform sends a notification to a customer that created the first complaint.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computer environment in which the present invention can be implemented;

FIG. 2 illustrates an exemplary website that can be provided by the platform to receive complaints from customers;

FIG. 3 illustrates an exemplary website that can be provided by the platform to display complaints that have been received from customers;

FIG. 4 illustrates an exemplary dashboard that can be displayed to a business for viewing complaints against the business;

FIG. 5 illustrates an exemplary window which can display the content of a selected complaint, and can include various options for addressing the complaint;

FIG. 6 illustrates an exemplary window for creating a settlement offer for a complaint;

FIG. 7 illustrates an exemplary window for sending a message to a customer;

FIG. 8 illustrates an exemplary window for requesting that a customer mark a complaint as resolved;

FIG. 9 illustrates an exemplary window for requesting assistance from the platform in resolving a complaint;

FIG. 10 illustrates another view of the dashboard of FIG. 4 when the activity history of a complaint is shown;

FIG. 11 illustrates another view of the dashboard of FIG. 4 when the business has a specified duration of time to respond to complaints prior to the complaints becoming publicly visible on the platform; and

FIG. 12 illustrates a flowchart of an exemplary method for providing a platform through which a business can resolve complaints with its customers.

### DETAILED DESCRIPTION

The present invention extends to methods, systems, and computer program products for providing a platform that enables a business to quickly and easily resolve complaints with its customers. The platform of the present invention provides a central location for accumulating complaints from customers of a business and presenting the complaints to the business for resolution. The platform also facilitates communication between the business and its customers to expedite the resolution of the complaints. In essence, the platform acts as a centralized intermediary between the customers and the businesses to promote the resolution of complaints in a fair and efficient manner.

In one embodiment, a method is implemented for providing a platform through which a business can resolve complaints with its customers. A platform hosted by a server system receives complaints from a plurality of customers. Each complaint specifies a business. The platform identifies each of the received complaints that specifies a first business. The platform provides a display of the received complaints that specify the first business to a computer system of the first business. The platform receives a selection of a first complaint from the computer system of the first business. In response to the selection of the first complaint, the platform sends a notification to a customer that created the first complaint.

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

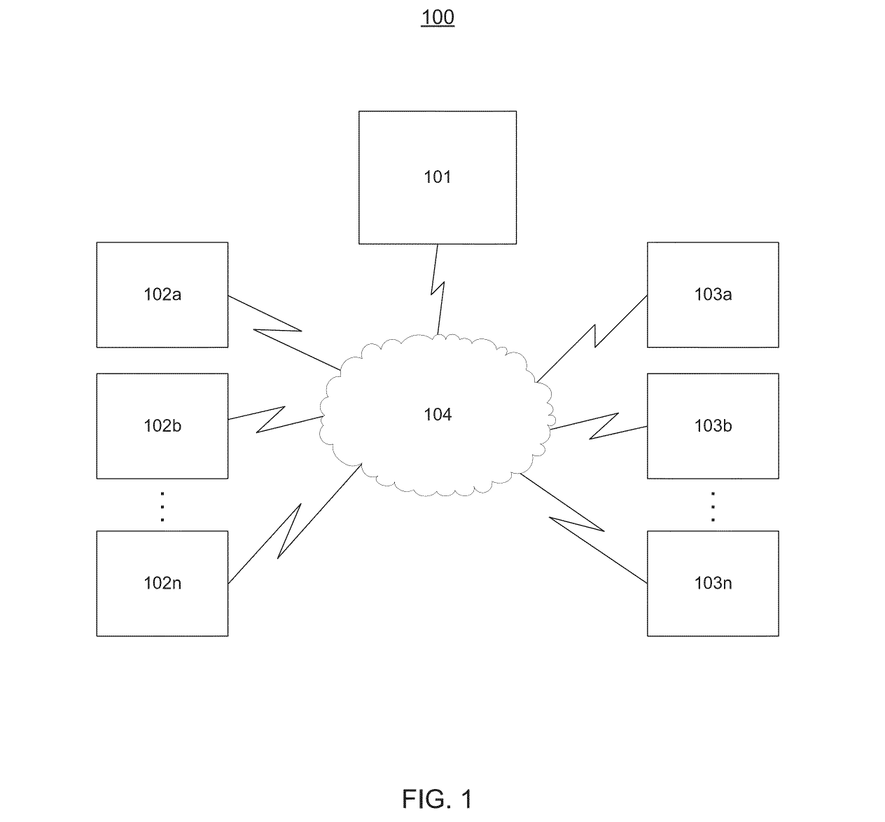

FIG. 1 illustrates an exemplary computer environment 100 in which the present invention can be implemented. Computer environment 100 includes server system 101, customer computer systems 102a-102n, and business computer systems 103a-103n which are interconnected via network 104. In a typical embodiment, network 104 is the internet.

Server system 101 hosts a platform for resolving complaints with customers. Server system 101 can comprise any number of computer systems or resources. For example, server system 101 can be a single server computing system, or can be a cloud of computer resources.

Customer computer systems 102a-102n can represent any type of computing device capable of communicating with server system 101 over network 104. Examples of customer computer systems 102a-102n include desktop computers, laptop computers, tablets, mobile phones, etc. In a typical embodiment, a customer uses one or more of customer computer systems 102a-102n to send communications to and receive communications from the platform hosted on server system 101.

Business computer systems 103a-103n, like customer computer systems 102a-102n, can represent any type of computing device capable of communicating with server system 101 over network 104. In a typical embodiment, an employee of a business uses one or more of business computer systems 103a-103n to send communications to and receive communications from the platform hosted on server system 101.

The computer systems depicted in computer environment 100 can intercommunicate in any suitable manner of communicating over network 104. For example, server system 101 can provide forms that users of systems 102 and 103 can fill out to provide information (e.g. using HTTP, SOAP or other protocols). Likewise, the systems can send emails, text messages, or similar types of messages to other systems. Specific examples of the types of communications that can be exchanged within computer environment 100 are provided below.

As stated above, server system 101 provides a platform for receiving complaints from customers, and for allowing businesses to resolve such complaints. The platform can be exposed as a website accessible to customers and businesses.

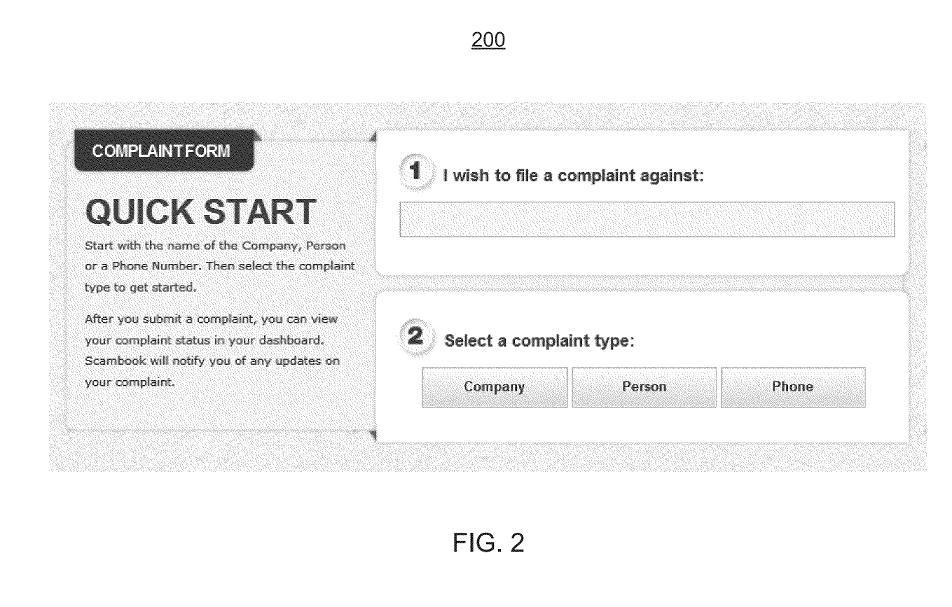

FIG. 2 illustrates an exemplary website 200 that can be provided by the platform to receive complaints from customers. In a basic example, a customer complaint can identify a business and provide the complaint. A complaint can also identify the type of entity the complaint is against such as a company, person, or phone number, provide an amount the customer is believed to be owed by the entity, and other details depending on the type of complaint.

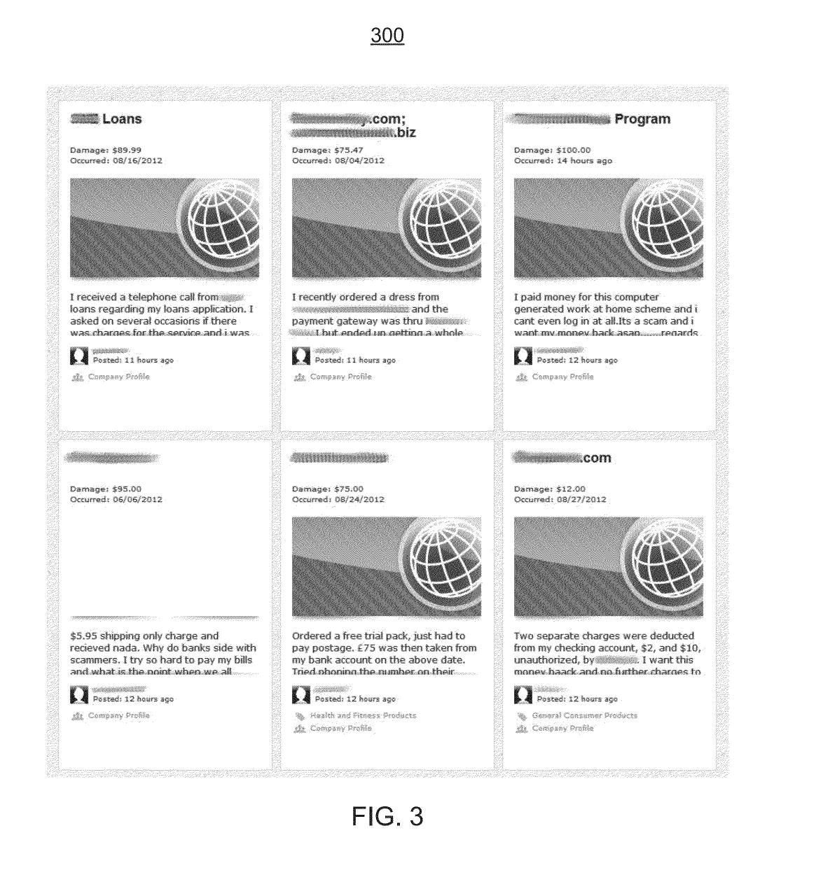

FIG. 3 illustrates an exemplary website 300 that can be provided by the platform to display complaints that have been received from customers. As shown, website 300 includes complaints against six different companies. Accordingly, the platform of the present invention provides a centralized location where customers can submit and view complaints against businesses.

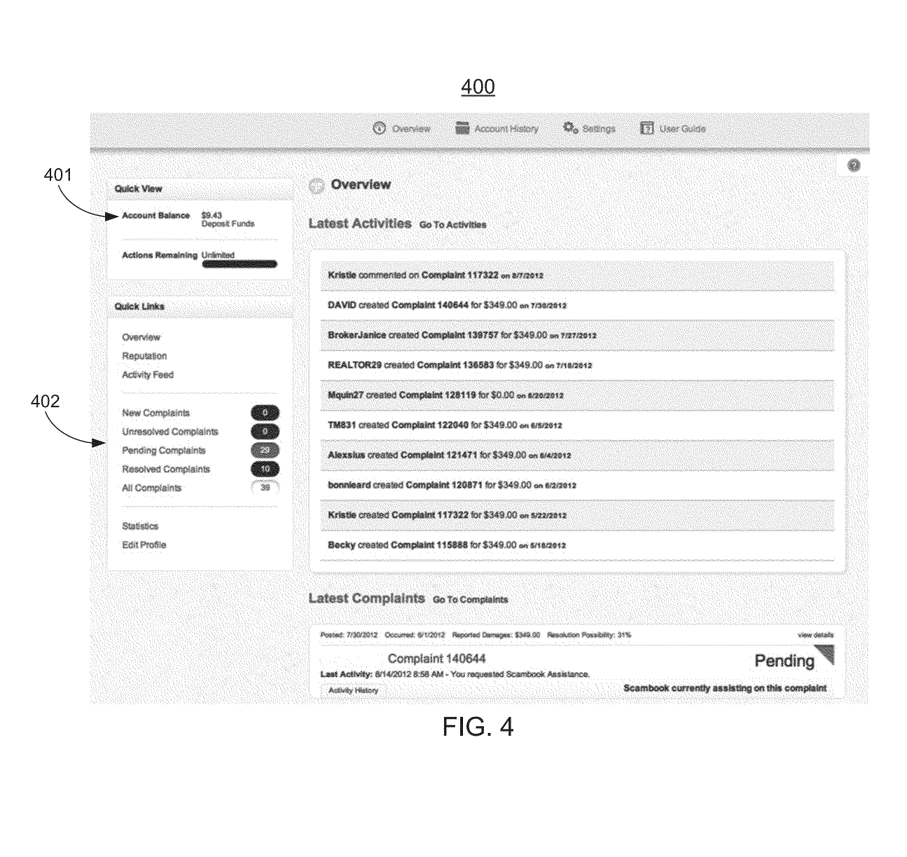

To facilitate the resolution of such complaints, the platform can enable a business to track each complaint that has been submitted against the business. As shown in exemplary dashboard website 400 in FIG. 4, the platform can allow a business to create an account to which any complaints against the business can be linked. A business's account can include an account balance 401 from which the business can make offers to resolve a complaint. Dashboard 400 can also display a summary 402 of the number of complaints a business has received including new complaints, unresolved complaints, pending complaints, and resolved complaints. In this manner, the platform provides a centralized dashboard that a business can quickly access to view and resolve its complaints.

A business's account can also include contact information for the business that can be displayed to customers. The contact information can allow customers to directly contact the business to attempt to resolve a complaint. Dashboard 400 can also provide statistics regarding a business's account such as the number of complaints received during a specified time period, the total amount of damages being claimed, the geographic location of complaints, the type or classification of complaints, etc.

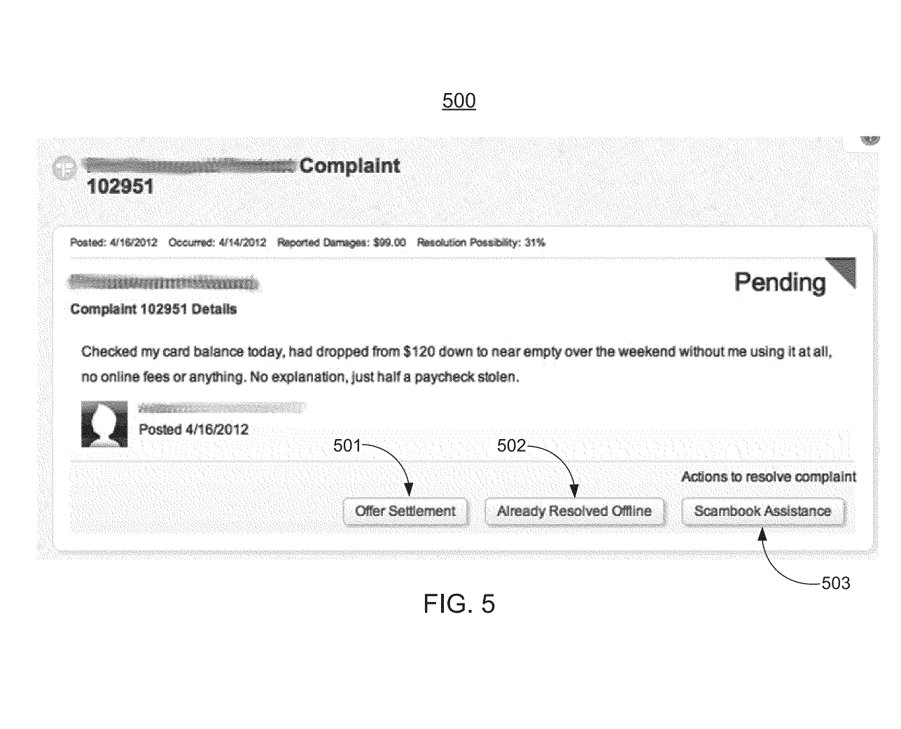

The platform can act as an intermediary for resolving complaints by routing communications between businesses and customers, and by transferring settlements amount from a business to a customer once a resolution has been reached. Accordingly, a business can maintain an account balance with the platform from which the platform draws founds for transferring accepted settlement amounts to customers. The process for facilitating the resolution of complaints will be further described with respect to FIGS. 5-11.

By selecting a particular complaint within its account, a business is provided an interface for initiating the resolution of the particular complaint. As shown in FIG. 5, the platform can provide a window 500 which displays the content of a selected complaint, and includes various options for addressing the complaint.

In exemplary window 500, three buttons are shown: offer settlement button 501, already resolved offline button 502, and assistance button 503. By selecting each button, the business can attempt to resolve a complaint in a different manner.

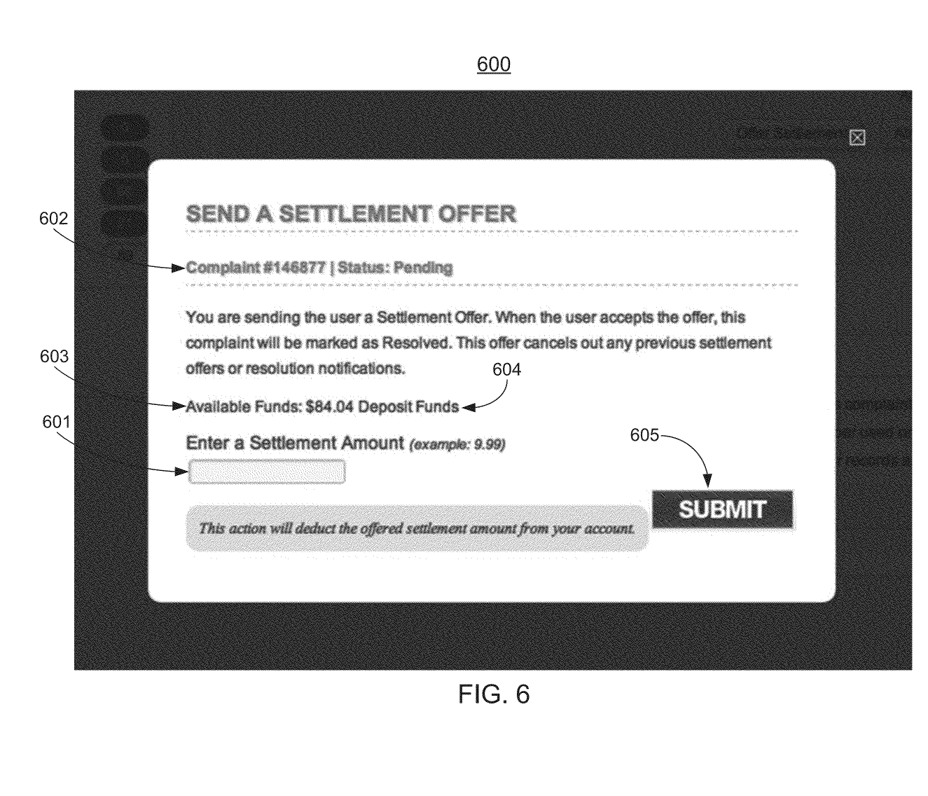

Selecting offer settlement button 501 causes the display of an exemplary offer settlement window 600 as shown in FIG. 6. Offer settlement window 600 prompts the user to input a settlement amount 601 to resolve the particular complaint 602. Offer settlement window 600 can also list the available funds 603 from which the business can make offers, as well as provide an option 604 to deposit funds. Once a settlement amount has been entered and the submit button 605 clicked, the platform generates and sends a notification to the customer that created the particular complaint informing the customer of the settlement amount. In some embodiments, the platform may also deduct the settlement amount from the business's account at the time the offer is made to ensure that the funds remain available if the customer accepts the offer.

The notification sent to the customer can be in the form of an email, text message, a post associated with the customer's account on the platform, or any other type of notification. The notification can include a link to a webpage provided by the platform in which the customer can accept the offered settlement amount, or can include functionality for accepting the offered settlement amount directly from the notification. The notification can also specify a time period during which the offer will remain valid (e.g. 7 days).

If a customer accepts an offered settlement amount to resolve a complaint, the settlement amount can be deducted from the business's account (if not already deducted) and provided to the customer. The payment of the settlement amount can be in any form, and in a particular embodiment, may be via an online payment provider such as PayPal.

Additionally, when the customer accepts an offered settlement amount, the complaint can be removed from the platform (e.g. can no longer be visible within website 200), or can be categorized as a resolved complaint which remains visible to users of the platform. Whether a resolved complaint remains visible to users can be a configurable option within each business's account.

For example, a business may desire that its resolved complaints remain visible to users to increase the business's reputation. In other cases, however, a particular complaint may be detrimental to the business whether it is resolved or not. Accordingly, the platform can provide the option to individually select which resolved complaints remain publicly visible. In either case, the business's resolved complaints can remain accessible to the business (e.g. via dashboard 400).

If a customer does not accept an offer (either by declining the offer or failing to accept the offer during the specified time period), a business may update the offered settlement amount. The platform notifies a customer of an updated settlement amount in a similar way that customers are notified of original settlement amounts (e.g. via email, text message, posting associated with customer's account on website, etc.). The platform may also provide means for a business to revoke an offered settlement amount.

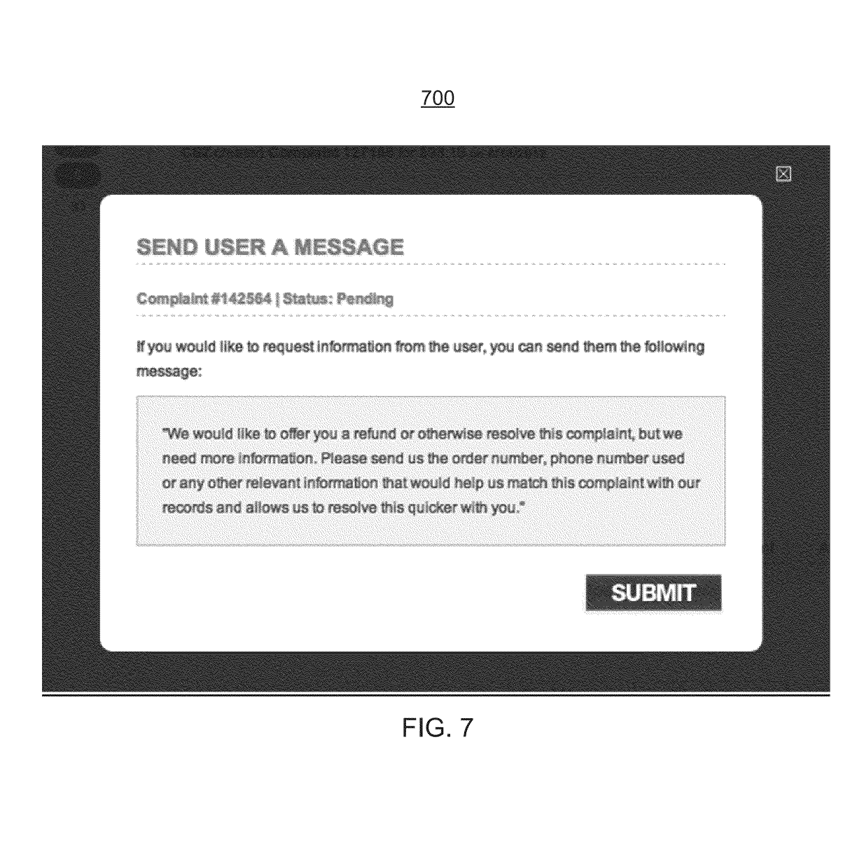

In addition to sending a settlement offer to a customer, a business can also contact the customer to request additional information regarding a complaint. For example, as shown in FIG. 7, an exemplary message window 700 can be displayed to a business to allow the business to contact a customer to request additional information regarding a complaint. Message window 700 provides a default message that is sent to the customer associated with the complaint when the submit button is selected. In some embodiments, message window 700 can also provide the option for the business to customize the message that will be sent to the customer.

Any response to a message received from a customer can be associated with the complaint and made available to the business (e.g. via dashboard 400). The business can then use any additional information in the response in determining whether to make a settlement offer as well as the amount of any offer, or to modify or revoke an existing settlement offer.

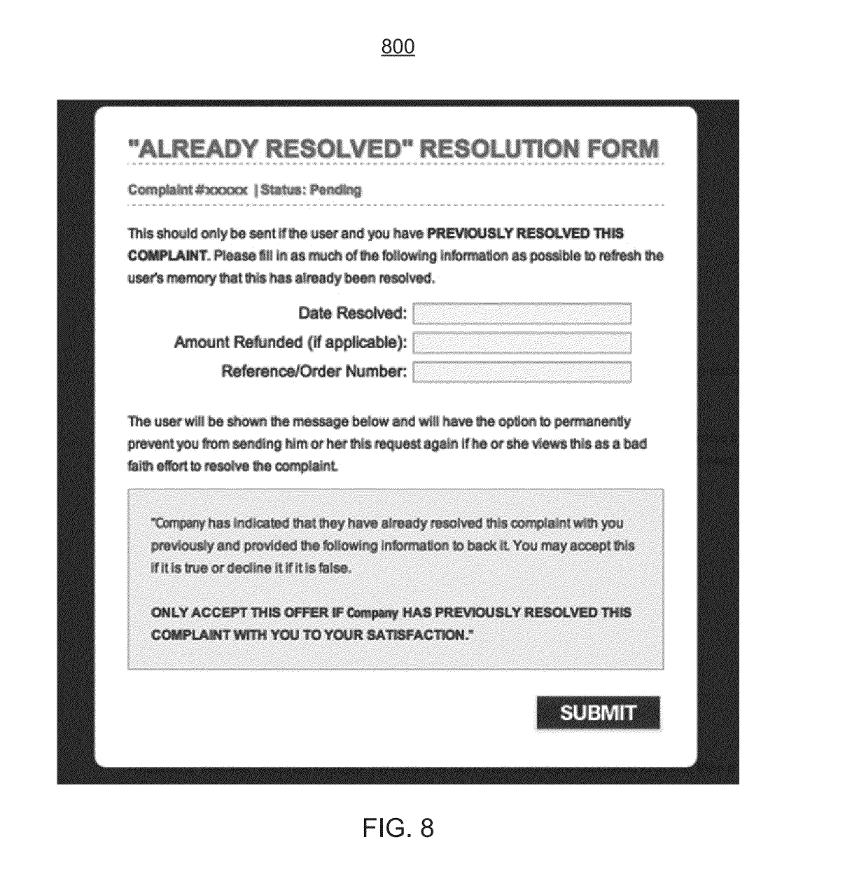

Returning to FIG. 5, if the business selects already resolved offline button 502, an exemplary request window 800 can be displayed as shown in FIG. 8. Request window 800 allows the business to send a request to the customer asking the customer to mark the complaint as resolved. For example, after a customer has created a complaint in the platform, the business and the customer may reach a resolution outside of the channels provided by the platform (e.g. by communicating directly with each other). In such cases, the business can resolve (and remove) the complaint within the platform by sending a request to the customer using request window 800.

Request window 800 allows the business to indicate the date the complaint was resolved and a settlement amount if applicable. This information is sent to the customer to request that the customer mark the complaint as resolved in the platform. If the customer declines the request (e.g. because the customer does not believe the business has resolved the complaint to the customer's satisfaction), the business can be notified accordingly, and the complaint will remain unresolved.

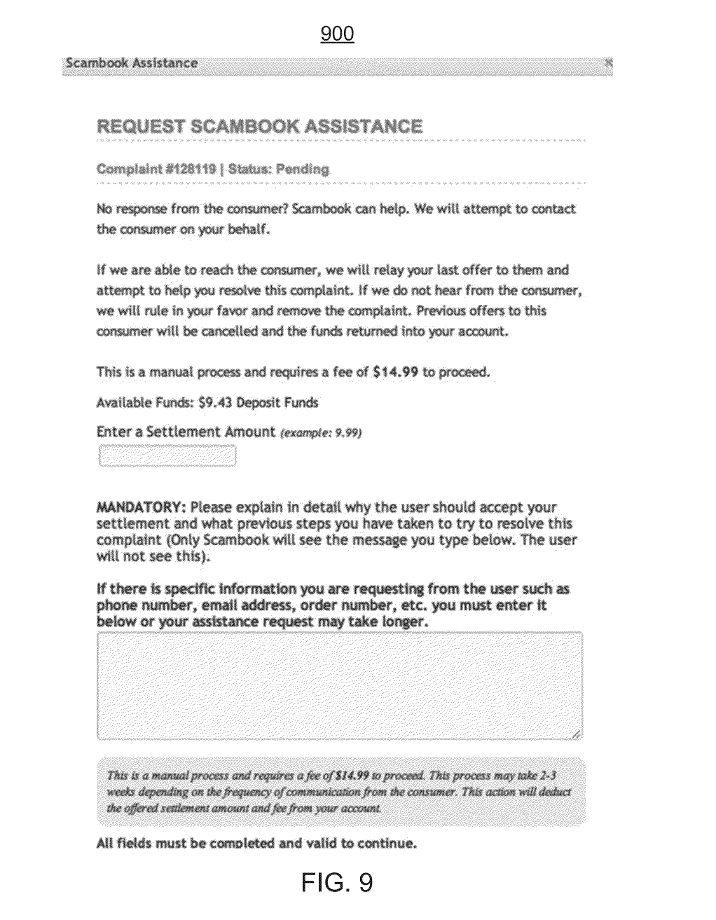

Returning again to FIG. 5, if the business selects assistance button 503, an exemplary assistance request window 900 can be displayed as shown in FIG. 9. For example, if a business is unable to resolve a complaint with a customer for any reason, including if the customer is not responding or is rejecting all settlement offers, the business can request the assistance of the platform.

Assistance request window 900 allows the business to provide information to the platform that can be used to attempt to manually resolve a complaint. For example, the business can input a settlement amount and an explanation for why the offer should be accepted. The platform can use this information to manually contact the customer to attempt to resolve the conflict. Manual resolution is intended to mean any attempt by the platform to directly resolve the complaint with the customer on behalf of the business, including direct phone calls, electronic communications, or the like made by agents of the platform to the customer. For example, an employee of a company providing the platform can attempt to call a customer to resolve a complaint in accordance with a business's request for manual assistance. In some embodiments, if the platform is unable to reach a resolution with the customer, the complaint will be marked as resolved.

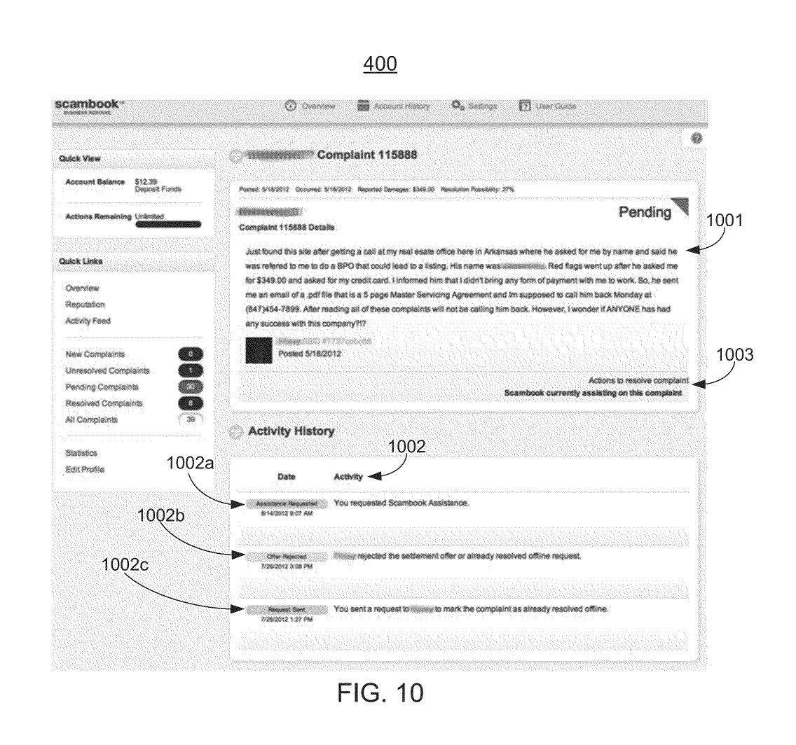

The platform can maintain a record of each activity that has been performed in attempting to resolve a complaint. As shown in FIG. 10, this record can be displayed within dashboard 400 after a business has selected to view a particular complaint (e.g. complaint 115888). As shown, dashboard 400 now displays the content 1001 of the complaint and the activity history 1002 of the complaint. Activity history 1002 lists each activity that has occurred with respect to the selected complaint. In this case, activity history 1002 includes request 1002a, response 1002b, and request 1002c.

Request 1002a comprises a request made by the business to mark the complaint as having been resolved offline (e.g. via already resolved offline button 502). Response 1002b indicates that the customer rejected the request to mark the complaint as having been resolved. Request 1002c comprises a request made to the platform for assistance (e.g. via assistance button 503). Because the business has requested assistance from the platform for this complaint, buttons 501-503 are no longer displayed, and have been replaced with status 1003.

Some businesses may desire to address complaints prior to the complaints being made publicly visible on the platform. The platform can also provide such functionality by delaying the publishing of complaints for a specified duration. During this specified duration, the business is notified of a complaint and given the opportunity to resolve the complaint before the specified duration has lapsed. If the business reaches a resolution within the specified duration, the complaint can be prevented from being published. Otherwise, the complaint can be made public as described above. In this way, a business can protect its reputation by resolving complaints before they become public.

In some embodiments, a business can be allowed to specify the duration of time before a complaint becomes public on the platform. For example, a business may specify a 24, 48, or 72 hour duration. In some embodiments, the duration can be determined based on a business's account level.

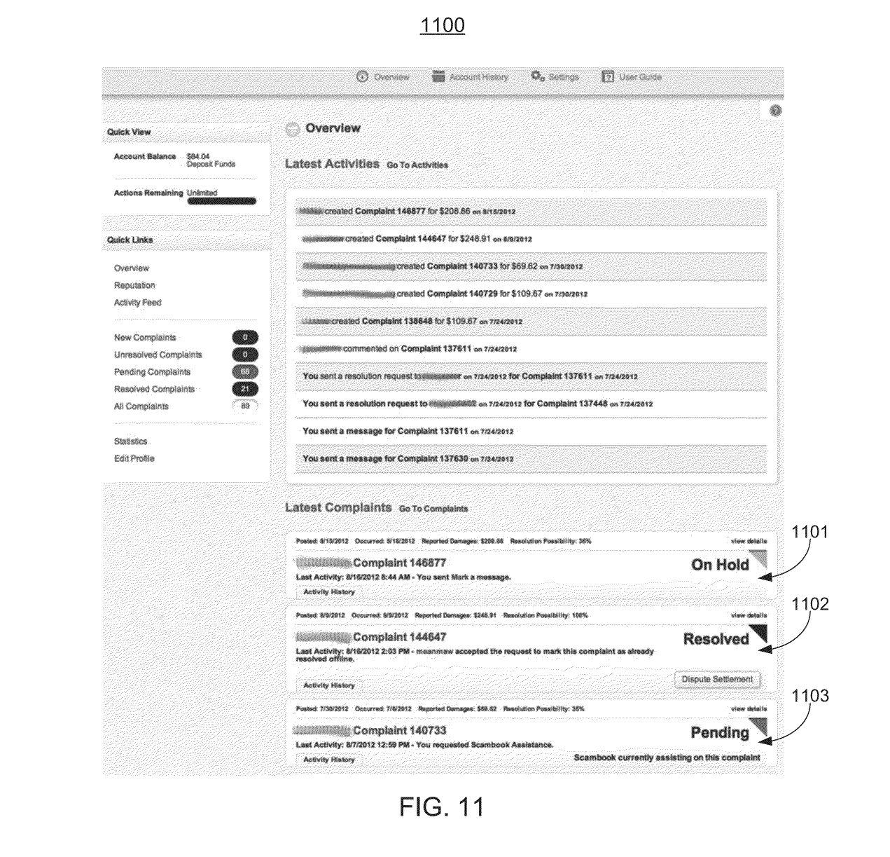

FIG. 11 illustrates an exemplary view of dashboard 400 when a business has a specified duration of time to respond to complaints prior to the complaints being published on the platform. As shown, the complaints can be displayed with a status indicator selected from on hold 1101, resolved 1102, or pending 1103. A status of on hold 1101 indicates that the complaint is within the initial window before the complaint has been made publicly visible. A status of resolved 1102 indicates that the complaint has been resolved. As stated above, a resolved complaint may or may not be publicly visible. A status of pending 1103 indicates that the complaint is pending and is publicly visible because it is outside the initial window.

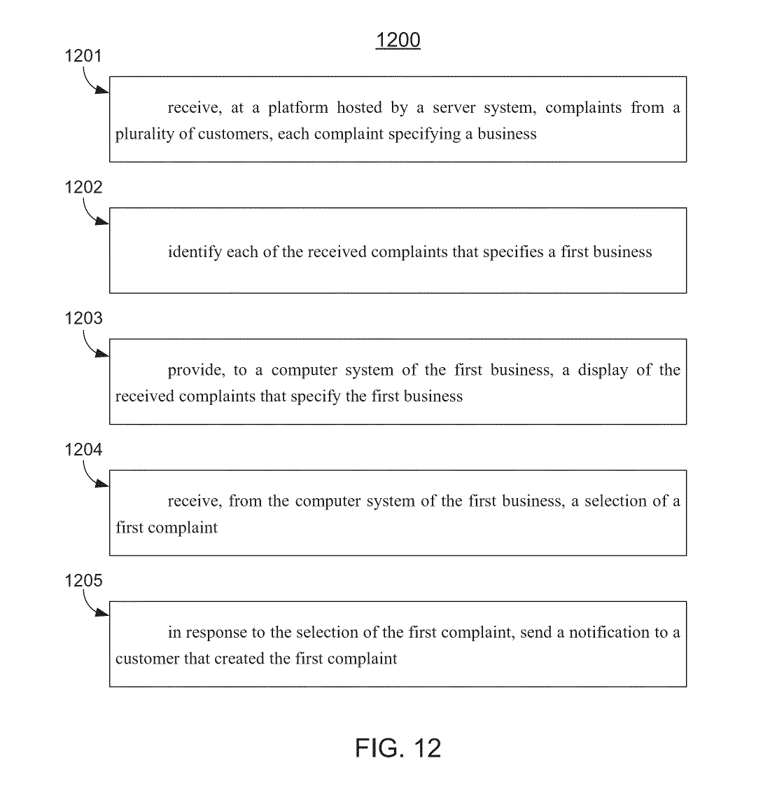

FIG. 12 illustrates a flowchart of an exemplary method 1200 for providing a platform through which a business can resolve complaints with its customers. Method 1200 will be described with respect to FIGS. 1 and 4.

Method 1200 includes an act 1201 of receiving, at a platform hosted by a server system, complaints from a plurality of customers, each complaint specifying a business. For example, server system 101 can host a platform and receive complaints from customer computer systems 102a-102n regarding various businesses.

Method 1200 includes an act 1202 of identifying each of the received complaints that specifies a first business. For example, the platform on server system 101 can identify a number of complaints that specify a first business.

Method 1200 includes an act 1203 of providing, to a computer system of the first business, a display of the received complaints that specify the first business. For example, the platform on server system 101 can provide a display of a number of complaints associated with the first business. The display can be in the form of a dashboard 400 and can be displayed on one or more of business computer systems 103a-103n.

Method 1200 includes an act 1204 of receiving, from the computer system of the first business, a selection of a first complaint. For example, the platform on server system 101 can receive the selection of one of the complaints that is displayed within the dashboard 400.

Method 1200 includes an act 1205 of, in response to the selection of the first complaint, sending a notification to a customer that created the first complaint. For example, the platform on server system 101 can send a notification to the customer that created the first complaint. The notification can be sent to or received by one or more of customer computer system 103a-103n.

Method 1200 can be implemented by one or more servers including distributed servers. For example, the platform that implements method 1200 can be in the form of a website hosted online whether by a single server computer system or within a cloud.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. In a computer environment, a method, performed by a server system, for providing a platform through which a business can resolve complaints with its customers, the method comprising:
receiving, at a platform hosted by a server system, complaints from a plurality of customers, each complaint specifying a business;
identifying each of the received complaints that specifies a first business;
providing, to a computer system of the first business, a display of the received complaints that specify the first business;
receiving, from the computer system of the first business, a selection of a first complaint; and
in response to the selection of the first complaint, sending a notification to a customer that created the first complaint.

2. The method of claim 1, wherein the notification comprises a settlement offer to resolve the complaint.

3. The method of claim 1, wherein the notification comprises a message requesting information from the customer regarding the complaint.

4. The method of claim 1, wherein the notification comprises a request that the customer mark the complaint as having been resolved.

5. The method of claim 2, wherein the display of the received complaints includes, for each complaint, an option to send a settlement offer to the associated customer to resolve the complaint.

6. The method of claim 5, wherein the option to send a settlement offer comprises a button that when selected displays a window for receiving an amount for the settlement offer.

7. The method of claim 2, further comprising:
receiving, from a computer system of the customer, an acceptance of the settlement offer.

8. The method of claim 7, further comprising:
in response to the acceptance of the settlement offer, removing the complaint from the platform.

9. The method of claim 7, further comprising:
in response to the acceptance, deducting an amount from an account of the first business; and
transferring at least a portion of the amount to an account of the customer.

10. The method of claim 2, further comprising:
receiving, from a computer system of the customer, a rejection of the settlement offer; and
sending a notification of the rejection to the computer system of the first business.

11. The method of claim 1, further comprising:
receiving, from the computer system of the first business, a request that the platform attempt to resolve the complaint with the customer.

12. The method of claim 11, further comprising:
attempting to resolve the complaint with the customer;
failing to resolve the complaint; and
removing the complaint from the platform.

13. The method of claim 1, further comprising:
publishing each complaint on the platform such that the complaints are publicly visible.

14. The method of claim 13, wherein each complaint that specifies the first business is published after a specified duration of time has elapsed from the time the complaint is received.

15. The method of claim 14, wherein the notification comprises a settlement offer to resolve the complaint, the method further comprising:
receiving, from a computer system of the customer, an acceptance of the settlement offer, the acceptance being received within the specified duration of time; and
preventing the complaint from publishing on the platform such that the complaint does not become publicly visible.

16. A server system that provides a platform through which a business can resolve complaints with its customers, the platform comprising computer executable instructions which when executed by one or more processors of the server system perform a method comprising:
receiving complaints from a plurality of customers, each complaint specifying a business;
identifying each of the received complaints that specifies a first business;
providing, to a computer system of the first business, a display of the received complaints that specify the first business;
receiving, from the computer system of the first business, a selection of a first complaint; and
in response to the selection of the first complaint, sending a notification to a customer that created the first complaint.

17. The server system of claim 16, wherein the notification comprises one of:
a settlement offer to resolve the complaint;
a message requesting information from the customer regarding the complaint; or
a request that the customer mark the complaint as having been resolved.

18. The server system of claim 17, wherein the notification is a settlement offer and includes a settlement amount, and wherein the method performed by the platform further comprises:
deducting the settlement amount from an account of the first business;
receiving, from a computer system of the customer, an acceptance of the settlement offer; and
in response to the acceptance of the settlement offer, transferring the settlement amount to an account of the customer.

19. The server system of claim 18, wherein the method performed by the platform further comprises:
publishing the received complaints on the platform such that the complaints are publicly visible.

20. The server system of claim 19, wherein complaints associated with at least one business are published after a first specified duration, and complaints associated with at least one other business are published after a second specified duration, the second specified duration being longer than the first specified duration.
